(19) United States
(12) Patent Application Publication
(10) Pub. No.: US 2010/0008419 A1
(43) Pub. Date: Jan. 14, 2010

(54) Hierarchical Bi-Directional P Frames

(75) Inventors: Hsi-Jung WU, San Jose, CA (US); James Oliver NORMILE, Los Altos, CA (US); Xiaojin SHI, Santa Cruz, CA (US); Xiaosong ZHOU, San Jose, CA (US); Gianluca FILIPPINI, Los Gatos, CA (US); Ionut HRISTODORESCU, San Jose, CA (US)

Correspondence Address: KENYON & KENYON LLP, 1500 K STREET NW, SUITE 700, WASHINGTON, DC, 20005-1257, US

(73) Assignee: APPLE INC., Cupertino, CA (US)

(21) Appl. No.: 12/339,735

(22) Filed: Dec. 19, 2008

Related U.S. Application Data
(60) Provisional application No. 61/079,631, filed on Jul. 10, 2008.

(51) Int. Cl. H04N 7/32

(52) U.S. Cl. 375/240.15; 375/E07.243

(57) ABSTRACT

Embodiments of the present invention provide systems, methods and apparatuses for generating forward, backward or bi-directional P frames. Prior to encoding a sequence of video frames, P frames within the video sequence can be reordered to include causal and/or non-causal references to one or more reference frames. This allows any block partition of a bi-directional P frame to include a single reference to a reference frame that is temporally displayed either before or after the bi-directional P frame. Compression and visual quality can therefore be improved. Hierarchical frame structures can be constructed using bi-directional P frames to better accommodate low complexity decoding profiles. Multilayered encoded video bitstreams can be generated based on the hierarchical frame structures and can include a first layer of anchor frames and one or more second layers that include bi-directional P frames that reference the anchor frames and/or any frame in any lower level layer.

### BACKGROUND OF THE INVENTION

1. Field of the Invention

The present invention generally relates to video encoding. More specifically, the present invention uses multiple reference frames to generate forward, backward or bi-directional P frames to facilitate construction of hierarchical frame structures to better accommodate low complexity decoder profiles.

2. Background Art

Many video encoders can generate encoded video using hierarchical B frames. The use of hierarchical B frames to encode video is well known. Exploitation of hierarchical B frames enables encoders to improve coding efficiency. Hierarchical B frames can also provide temporal scalability and better drift control (e.g., reducing error propagation).

Many video decoding devices are low power and/or low complexity devices. These resource-limited decoders generally have restricted capabilities in terms of processing speed and/or power constraints and are unable to support B frames, whether or not hierarchically arranged. For example, devices that conform to the “baseline profile” specified by the H.264 standard cannot decode B frames. Consequently, many playback devices cannot exploit the benefits of hierarchical B frames.

Accordingly, there is a need to develop encoding techniques to enable low complexity decoders to exploit the benefits of hierarchically arranged frame structures that do not require B frames.

### BRIEF DESCRIPTION OF THE DRAWINGS

FIG. 1 illustrates a simplified block diagram of a Group of Pictures (GOP) encoded according to one embodiment of the present invention.

FIG. 2 illustrates a simplified block diagram of a hierarchical frame structure generated according to one embodiment of the present invention.

FIG. 3 illustrates an encoded video bitstream generated according to one embodiment of the present invention.

FIG. 4 provides a flowchart illustrating a method for encoding and decoding a video sequence according to one embodiment of the present invention.

FIG. 5 is a simplified functional block diagram of a computer system.

### DETAILED DESCRIPTION OF THE INVENTION

Embodiments of the present invention provide systems, methods and apparatuses for generating forward, backward or bi-directional predictive frames (i.e., P frames). According to an aspect of the present invention, prior to encoding a sequence of video frames, P frames within the video sequence can be reordered to include causal and/or non-causal references to one or more reference frames. This allows any block partition of a bi-directional P frame to include a single reference to a reference frame that is temporally displayed either before or after the bi-directional P frame. As a result, compression and visual quality can be improved.

Hierarchical frame structures can be constructed using bi-directional P frames during the encoding process. Such hierarchical frame structures can better accommodate low complexity decoding profiles (e.g., devices conforming to the baseline profile specified in the International Telecommunication Union (ITU) H.264 standard). Multilayered encoded video bitstreams can be generated based on the hierarchical frame structures. Specifically, in a multilayered encoded video bitstream, a first layer can include anchor frames while one or more second layers can include bi-directional P frames that reference the anchor frames and/or one or more frames in a lower level layer.

The encoding techniques of the present disclosure provide temporal scalability and flexibly accommodate a wide range of decoders. The encoding techniques of the present disclosure also improve the coding efficiency and visual quality of video sequences decoded by low complexity decoders. Further, the techniques of the present disclosure can improve error resiliency during decoding since frame dependencies can be broken up by layers. For example, if a network connection introduces a large number of errors into a high level layer of the encoded hierarchical structure, then a decoder can simply ignore the corrupted layers during decoding. In this way, errors experienced by a corrupted layer of the multilayered encoded bitstream need not necessarily affect the decoding performance and visual quality of the remaining encoded layers of the hierarchical structure. Drift control can also be improved, in a manner similarly provided by hierarchical B frames, since frame dependencies can be contained to be within a Group of Pictures (GOP).

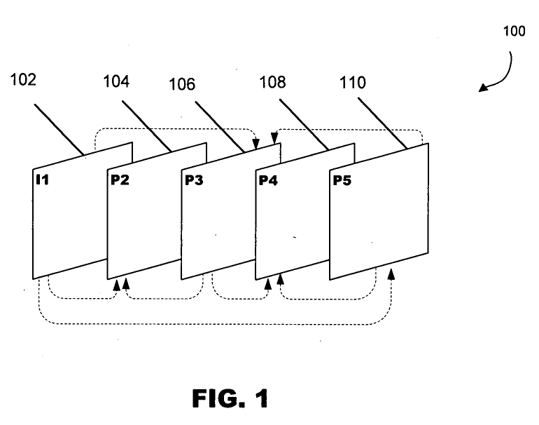

FIG. 1 illustrates a simplified block diagram of a GOP 100 encoded according to one embodiment of the present invention. The GOP can include a number of frames 102 through 110. The frame order for display and encoding can be determined by an encoder operating according to an aspect of present invention. The frame order depicted in FIG. 1 can be the display order for the frames comprising the GOP 100.

Frame 102 is an I frame and represents the beginning of the GOP 100. Frame 110 is a P frame referencing to frame 102 and represents the end of the GOP 100. Frames 102 and 110 can be considered anchor reference frames. These anchor reference frames can form the first layer of a hierarchical frame structure. That is, frames 102 and 110 can form the first layer (e.g., a base layer) of a multilayered encoded video bitstream. Frames 102 and 110 can be frames that should be decoded before decoding and exploiting frames forming portions of a second or higher layer (e.g., an enhancement layer) of a multilayered encoded video bitstream.

Frames 104, 106 and 108 are each P frames. Frame 106 can form a second layer of the hierarchical frame structure. Specifically, frame 106 need not be decoded and displayed by a decoder but can be decoded to improve temporal scalability and/or visual quality if so desired. Frame 106 can reference from both frame 102 and frame 110 (as indicated by the arrows illustrated in phantom). As such, frame 106 is a bi-directional P frame. Frame 102 can be considered a causal reference for frame 106 as frame 102 occurs prior to frame 106 temporally. Frame 110 can be considered a non-causal reference for frame 106 as frame 110 occurs subsequent to frame 106 temporally. Both frames 102 and 110 can be reordered prior to encoding so that they can be encoded prior to frame 106.

By exploiting both causal and non-causal references, an aspect of the present invention can enable the construction of hierarchical frame structures using bi-directional P frames. The exploitation of non-causal references allows frame 106 to use prediction information for pixel regions that would otherwise be occluded when limited to only causal references.

The references to frames 102 and 110 used by frame 106 can be generated on a block partition basis. That is, a P frame can be broken into several similarly sized partitions (e.g., an 8×8 pixel region, 16×8 pixel region, etc.). Each block partition of a bi-directional P frame of the present invention can include a reference to either a forward-looking or backward-looking reference frame. As illustrated in FIG. 1, at least one block partition of frame 106 includes a backward-looking reference to frame 102, which temporally occurs prior to frame 106. Similarly, as depicted in FIG. 1, at least one block partition of frame 106 includes a forward-looking reference to frame 110, which temporally occurs subsequent to frame 106.

As further illustrated in FIG. 1, frame 104 includes one or more references to frame 102 and frame 106. Frame 108 includes one or more references to frame 106 and 110. Frames 104 and 108 together can form a third layer of the hierarchical frame structure. Specifically, frames 104 and 108 need not be decoded by a decoder but can be decoded to improve temporal scalability or visual quality if so desired. If frames 104 and 108 are corrupted heavily with errors during transmission, then a decoder can decide to drop the layers for decoding—e.g., the decoder can decide not to decode the frames if their resulting visual quality would not make it desirable to do so. The errors experienced by frames 104 and 108 would not affect the decoding and resulting visual quality of the lower level layers of the hierarchical structure.

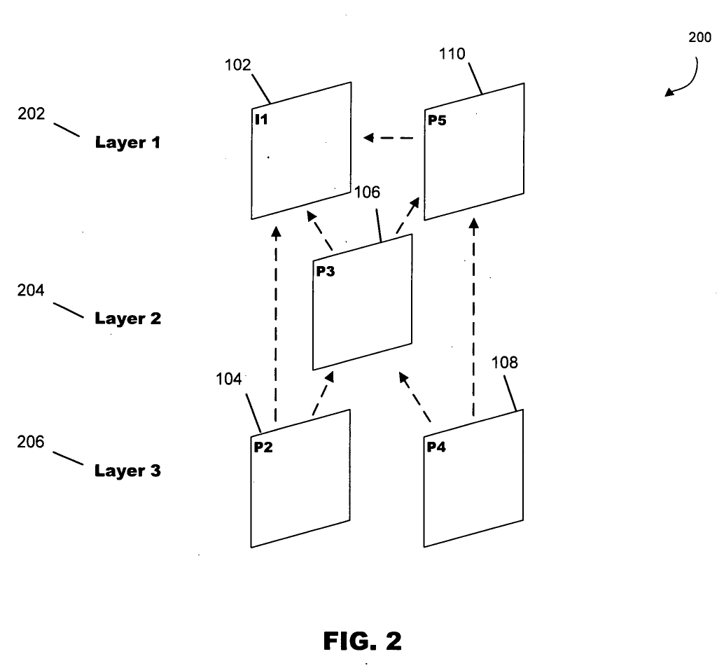

FIG. 2 illustrates a simplified block diagram of a hierarchical frame structure 200 generated according to one embodiment of the present invention. The hierarchical frame structure 200 can be based upon the construction of bi-directional P frames. As an example, the hierarchical frame structure 200 can be based upon the GOP 100 and frame dependencies depicted in FIG. 1.

As shown in FIG. 2, the hierarchical frame structure 200 includes a first layer 202, a second layer 204 and a third layer 206. The first layer includes anchor reference frames 102 and 110. The second layer includes frame 106. The third layer 206 includes frames 104 and 108. The hierarchical nature of the frame structure 200 is illustrated by the arrows which indicate reference frame dependencies. Specifically, frames of a higher layer can reference any frame of one or more lower layers. Frame 106 of the second layer 204 references frames 102 and 110 of the first layer 202. Frames 104 and 108 of the third layer 206 reference frames 102 and 110, respectively, of the first layer 202 and also reference frame 106 of the second layer 204.

Each layer of the hierarchical frame structure 200 can be included as a different layered portion of an encoded video bitstream provided to a downstream video decoder. That is, frames 102 and 110 can form a base layer, frame 106 can form a separate first enhancement layer and frames 104 and 108 can form a still separate second enhancement layer.

Based on the capabilities of the decoder (e.g., processing power/speed and other decoding resources), the decoder can chose how many enhancement layers to decode beyond the baseline layer (i.e., layer 202). By encoding frames 102 through 110 hierarchically, an encoder of the present invention can introduce temporal scalability into the resulting encoded bitstream. Further, coding efficiency can be improved by relying on hierarchical dependencies as less video content information may be encoded at higher layers.

An encoder of the present invention can generate the hierarchical structure and dependencies as illustrated in FIG. 2. Specifically, an encoder operating according to the present invention can determine how many hierarchical layers should be generated and which decoder profile and/or network condition should be matched to a particular layer of encoding. An encoder operating according to the present invention can determine the encoding order for a sequence of frames forming a GOP, which frames should be anchor frames and which frames can form portions of higher layer encoded video.

Furthermore, an encoder operating according to the present invention can determine which type of reference (either a forward or backward reference) will be associated with a particular block partition of a bi-directional P frame. The use of forward/non-causal references can improve visual quality and coding efficiency by enabling prediction of occluded pixel partitions that previously could not be predicted when limited to backward-looking references. Errors across GOPs can also be limited by restricting the constructed hierarchical structures, and the frame reference dependencies therein, to within a single GOP.

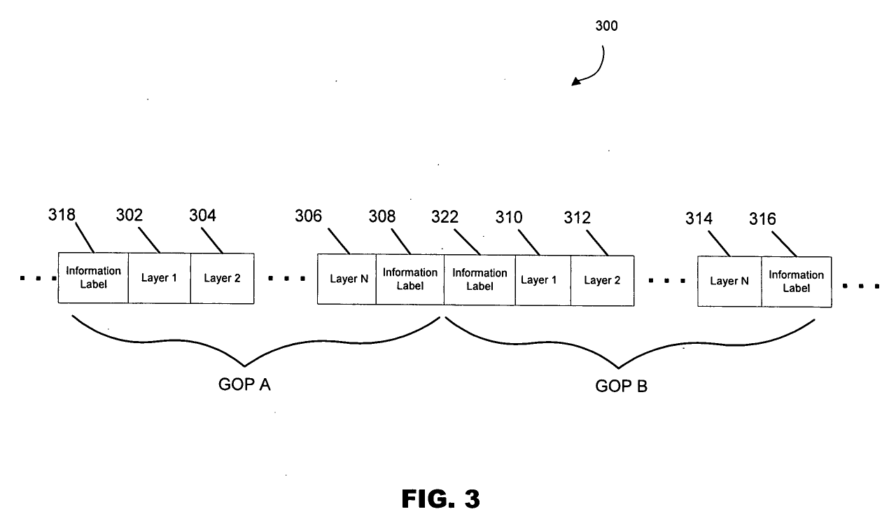

FIG. 3 illustrates an encoded video bitstream 300 generated according to one embodiment of the present invention. The bitstream 300 includes encoded video for two GOPs. Each GOP can be encoded using hierarchical bi-directional P frames in accordance with aspects of the present invention. The first GOP comprises a multilayered encoded bitstream comprising encoded video for a number of encoded layers of video 302 through 306. Specifically, the first GOP depicted includes a first or baseline encoded layer 302, a second or first enhancement layer 304 and a last or nth enhancement layer 306. Similarly, the second GOP comprises a multilayered encoded bitstream comprising encoded video for a number of encoded layers of video 310 through 314. Specifically, the second GOP depicted includes a first or baseline encoded layer 310, a second or first enhancement layer 312 and a last or nth enhancement layer 314. Frames of different layers can also interleave with each other in the bitstream.

Each layer of a resulting encoded hierarchical frame structure contained within a GOP can be labeled and associated with target decoder device types during the encoding process. That is, during encoding, an encoder of the present invention can specify which layers are associated with particular device profiles. This labeling information can be contained in the bitstream 300 using labels. For example, labels may be Supplemental Enhancement Information (SEI) messages in accordance with the Advanced Video Coding (AVC)/H.264 standard. In one or more exemplary embodiments, the SEI messages may also contain out of band information.

Informational labels (e.g., SEI messages) may be at the start and/or end of GOPs. As an example, information label 308, which is at the end of GOP A, can specify which layer or layers of the first GOP are directed to a specific device type. Consequently, a decoder that receives the bitstream 300 can, from a review of the information label 308, determine which layers 302 through 306 should be used for decoding a GOP and which layers can or should be ignored. As an example, a first layer (e.g., layer 302) can be specified for use by all devices/baseline devices; a second layer (e.g., layer 304) can be specified for use by more advanced decoders and/or decoders with less disruptive network restrictions; and a third layer (e.g., layer 308) can be specified for the most advanced devices having no network restrictions. Device-based layer labels can vary for each GOP in the bitstream 300. Information label 318, which is at the beginning of GOP A, may contain same information as information label 308. Because the information label 318 may contain out-of-band information at the beginning of the GOP, a video distribution server (e.g., a sync server) may use the information label 318 to filter the bitstream. Such that certain layers that a recipient decoder will not be able to play will not be transmitted to the recipient decoder unnecessarily. Information labels 316 and 322 may contain similar information as information labels 308 and 318 respectively. In one exemplary embodiment, each GOP may only include an information label at the beginning. In another exemplary embodiment, each GOP may only include an information label at the end. In yet another exemplary embodiment, each GOP may include information labels at both beginning and end. In one embodiment, information labels 308, 316, 318 and 322 may be implemented in SEI messages. In another embodiment, those information labels may be implemented in other formats that contain the label information and/or out of band information. Further, the informational label may contain other information of the bitstream.

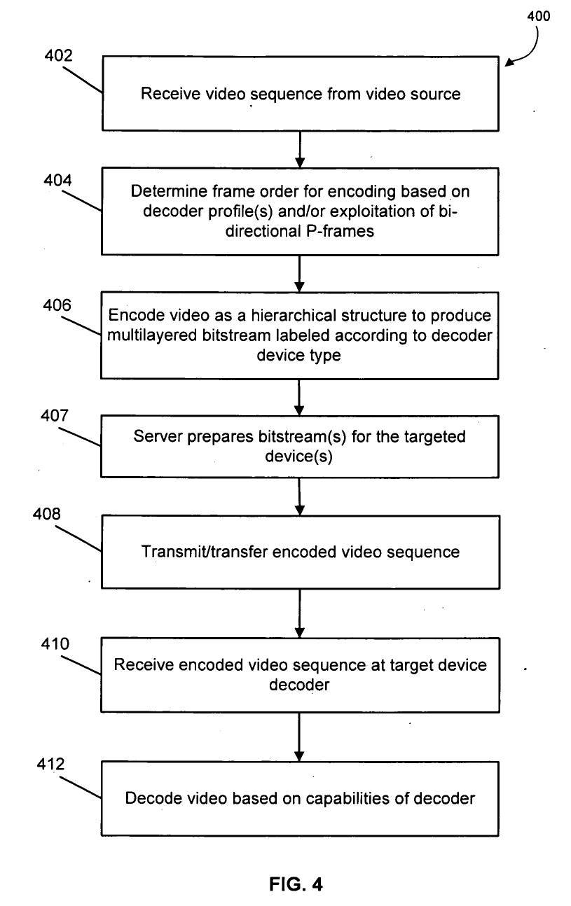

FIG. 4 provides a flowchart illustrating a method 400 for encoding and decoding a video sequence according to one embodiment of the present invention. The method 400 can be implemented to generate a hierarchical frame structure based on bi-directional P frames. The method 400 can enable an encoder operating according to an aspect of the present invention to accommodate a large range of decoder devices having different performance profiles and capabilities.

At step 402, a video sequence is received from a video source. The video sequence can contain a number of video frames.

At step 404, an order for encoding the video frames is determined. The order for encoding can be determined based on one or more target decoder profiles. The order for encoding can also be determined by the ability to encode bi-directional P frames. That is, frames determined to be P frames can be rearranged to include both causal and non-causal references to one more reference frames.

At step 406, the rearranged video frames are encoded to form a hierarchical frame structure comprising multiple layers of encoded video. The hierarchical frame structure can be confined to a GOP. Each layer of the resulting hierarchical frame structure can be labeled and associated with one or more target decoder device types during the encoding process. For example, information labels (e.g., SEI messages, in accordance with H.264 ), can be generated for each GOP to specify which particular layers of the resulting hierarchical encoded structure are to be decoded by corresponding decoders. For example, a first layer can be labeled as available for all devices including baseline devices. A second layer can be labeled as directed to more advanced decoders and/or decoders with less disruptive network restrictions. Similarly, a third layer can be generated and directed to the most advanced decoder devices having no network restrictions.

At step 407, a server may prepare bitstream(s) for targeted device(s). A video distribution server may be used to transmit encoded videos to decoder devices. In one embodiment, not the whole encoded video will be transmitted. For example, a video distribution center (e.g., a sync center) may decide to throw away data contained in layers higher than a certain layer when it knows a recipient (e.g., a playback device) that will play the content cannot decode layers higher than the certain layer.

At step 408, the encoded video is transmitted across a network as a multi-layered bitstream.

At step 410, the encoded video is received by a target decoder device. In one or more exemplary embodiments, not the whole encoded video but selected parts may be received. For example, when a video distribution center (e.g., a sync center) decide to throw away data contained in layers higher than a certain layer, a recipient will not receive layers of encoded data it won't be able to play anyways. Thus, smaller file size may be achieved for transmission and the recipient needs not receive the whole encoded video.

At step 412, the target decoder device decodes the encoded video based on the capabilities of the decoder. Specifically, the decoder can review the information labels (e.g., SEI messages) used to label the layers of the encoded video and can determine which layers to use for decoding. The target decoder can determine the one or more layers to decode for an entire encoded sequence or can dynamically adjust which layers to decode based on varying network conditions and varying capabilities of the decoder.

According to a further aspect of the present invention, scalable bitstreams can be generated based on a hierarchical coding structure provided by features of the present invention. That is, one or more side channels in an encoded video bitstream can be used to carry B frames. The side channels can be used by a decoder device that can decode B frames. For example, a baseline layer of an encoded bitstream can include I and P frames and no B frames. A first set of enhancement layers can include bi-directional P frames while a second set of enhancement layers can include B frames, whether or not bi-directional. The second set of enhancement layers can be used as an alternative set of enhancement layers that can be used and exploited by a decoder capable of decoding B frames. The alternative layer can contain fewer bits than the layer containing only P frames yet can reproduce a video frame of substantially similar visual quality or can contain similar bits yet can reproduce a video frame of better visual quality.

In this way, encoded bitstreams can be developed that can comprise lower layers of encoded video that is shared by all downstream decoders while higher layers of encoded video can be tailored to different decoders. To improve coding efficiency, some decoders having the ability to decode B frames can replace the higher layer P frame only layers with alternative layers that include B frames. The side channel information carrying the alternative layers having B frames can be included in the bitstream depicted in FIG. 3. Informational labels (e.g., SEI messages) or side channels can be used to specify alternative layers containing B frames.

According to a further aspect of the present invention, a repository for encoded video can generate demuxable bitstreams according to an aspect of the present invention. A repository of encoded video can be, for example, a server/service (e.g., iTunes) that synchs multiple remote decoder devices to encoded video.

When a new sequence of video is to be made available for download, the repository can download or prepare multiple bitstreams for download. That is, the repository can download or generate encoded video for download by a wide range of decoder devices. The downloaded encoded video can include labels specifying which layers are intended for specific decoder devices or profiles. Accordingly, based on the capabilities of the particular decoder attempting to download an encoded video bitstream from the repository, the repository can use the labels to determine exactly what portions of the bitstream the decoder needs for decoding. These decisions—which bitstream and which layers of a particular bitstream to provide to the downstream device—can be made dynamically during download as network conditions vary. This technique generates an efficient bitstream for download by a target device and limits the amount of unnecessary transmitted to the decoder. In essence, a bitstream is tailored for download by the server repository prior to transmission according to device-based layer labels.

An encoder of the present invention can include an encoding unit and a control unit. The encoding unit can perform the functions of encoding video data based on control information or coding directions received from the control unit. Specifically, the control unit can determine the arrangement of video frames for encoding, frame types, and a hierarchical frame structure for encoding based on exploitation of bi-directional P frames. The control unit can also generate or specify the information labels (e.g., SEI messages) to be included in the resulting encoded bitstream.

A decoder of the present invention can include a decoding unit and a control unit. The control unit can receive and decode the information labels (e.g., SEI messages) in a received bitstream. The control until can subsequently direct the decoder unit to decode the encoded video in particular manner based on the information labels (e.g., SEI messages) and the capabilities of the decoder.

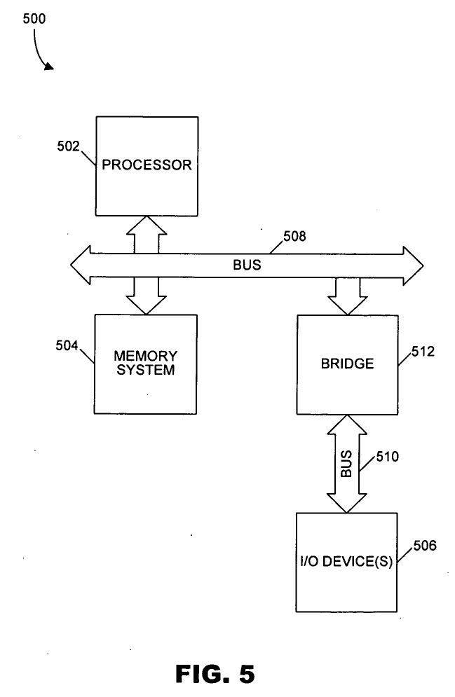

An encoder and decoder of the present invention can be implemented in hardware, software or some combination thereof. For example, an encoder and/or decoder of the present invention can be implemented using a computer system. FIG. 5 is a simplified functional block diagram of a computer system 500.

As shown in FIG. 5, the computer system 500 includes a processor 502, a memory system 504 and one or more input/output (I/O) devices 506 in communication by a communication ‘fabric.’ The communication fabric can be implemented in a variety of ways and may include one or more computer buses 508, 510 and/or bridge devices 512 as shown in FIG. 5. The I/O devices 506 can include network adapters and/or mass storage devices from which the computer system 500 can receive compressed video data for decoding by the processor 502 when the computer system 500 operates as a decoder. Alternatively, the computer system 500 can receive source video data for encoding by the processor 502 when the computer system 500 operates as an encoder.

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A method, comprising:
receiving, at a video encoder, video data from a video source;
determining an order for encoding frames of the video data;
encoding the frames according to a hierarchical structure, the hierarchical structure comprising:
a baseline encoded layer containing one or more reference anchor frames; and
an enhancement encoded layer containing at least one bi-directional P frame, the bi-directional P frame referencing at least one of the one or more reference anchor frames of the baseline encoded layer; and
transmitting the encoded frames to a downstream decoder as an encoded video bitstream.

2. The method of claim 1, wherein encoding further comprises, for the at least one bi-directional P frame, determining on a block partition basis which of the one or more reference anchor frames to reference.

3. The method of claim 2, wherein the at least one bi-directional P frame includes at least one causal reference.

4. The method of claim 2, wherein the at least one bi-directional P frame includes at least one non-causal reference.

5. The method of claim 1, further comprising:
generating an information label to specify at least one decoder profile corresponding to each layer of the hierarchical structure; and
including the information label in the encoded video bitstream.

6. The method of claim 5, wherein the information label is a Supplemental Enhancement Information (SEI) message in accordance with the Advanced Video Coding (AVC)/H.264 standard.

7. The method of claim 1, further comprising generating an alternative enhancement encoded layer, the alternative enhancement encoded layer containing at least one B frame to replace the at least one bi-directional P frame of the enhancement encoded layer.

8. An encoder, comprising:
a control unit; and
an encoding unit to receive video data from a video source and to encode the video data in accordance with instructions specified by the control unit, wherein the control unit:
determines an order for encoding frames of the video data; and
specifies the encoding of the frames according to a hierarchical structure, the hierarchical structure comprising:
a baseline encoded layer containing one or more reference anchor frames; and
an enhancement encoded layer containing at least one bi-directional P frame, the bi-directional P frame referencing at least one of the one or more reference anchor frames of the baseline encoded layer.

9. The encoder of claim 8, wherein the control unit, for the at least one bi-directional P frame, determines on a block partition basis which of the one or more reference anchor frames to reference.

10. The encoder of claim 9, wherein the at least one bi-directional P frame includes at least one causal reference.

11. The encoder of claim 9, wherein the at least one bi-directional P frame includes at least one non-causal reference.

12. The encoder of claim 8, wherein the control unit further specifies at least one decoder profile corresponding to each layer of the hierarchical structure.

13. The encoder of claim 12, wherein the encoding unit generates an information label corresponding to the decoder profile specified by the control unit.

14. The encoder of claim 13, wherein the encoding unit constructs the information label within the encoded video bitstream.

15. The encoder of claim 13, wherein the information label is a Supplemental Enhancement Information (SEI) message in accordance with the Advanced Video Coding (AVC)/H.264 standard.

16. The encoder of claim 8, wherein the control unit specifies an alternative enhancement encoded layer, the alternative enhancement encoded layer containing at least one B frame to replace the at least one bi-directional P frame of the enhancement encoded layer.

17. A method, comprising:
receiving, at a decoder, an encoded video bitstream, the encoded video bitstream comprising a hierarchical structure of encoded video frames containing:
a baseline encoded layer containing one or more reference anchor frames;
an enhancement encoded layer containing at least one bi-directional P frame, the bi-directional P frame referencing at least one of the one or more reference anchor frames of the baseline encoded layer; and
an information label specifying a decoder profile that corresponds to each layer of the hierarchical structure;
reviewing the information label to determine which layers of the hierarchical frame structure to decode;
selecting the determined layers and ignoring all remaining layers;
decoding the determined layers based on instantaneous capabilities of the decoder.

18. The method of claim 17, wherein the video bitstream is received from a distribution center and the distribution center is adapted to transmit video bitstreams according to a recipient's decoding capability.

19. The method of claim 18, further comprising:
reviewing the information label to determine which layers of the hierarchical frame structure to sync to the distribution center.

20. The method of claim 19, wherein the information label is a Supplemental Enhancement Information (SEI) message.

21. A method, comprising:
receiving, at a decoder, an encoded video bitstream, the encoded video bitstream comprising a hierarchical structure of encoded video frames containing:
a baseline encoded layer containing one or more reference anchor frames;
an enhancement encoded layer containing at least one bi-directional P frame, the bi-directional P frame referencing at least one of the one or more reference anchor frames of the baseline encoded layer;
an alternative enhancement encoded layer containing at least one B to replace the at least one bi-directional P frame of the enhancement encoded layer; and
an information label specifying a decoder profile that corresponds to each layer of the hierarchical structure;
reviewing the information label to determine which layers of the hierarchical frame structure to decode;
selecting the determined layers and ignoring all remaining layers;
decoding the determined layers based on instantaneous capabilities of the decoder.

22. A method, comprising:
receiving video data from a video source;
grouping frames of the video data into one or more picture groups;
for each picture group:
selecting a first set of frames as anchor frames;
encoding the first set of frames as a baseline encoded layer;
selecting a second set of frames;
for each frame in the second set of frames:
determining, on a block partition basis, which anchor frame to reference;
encoding the second set of frames as a first enhancement encoded layer with each frame of the second set encoded as a P frame;
selecting a third set of frames;
for each frame in the third set of frames:
determining, on a block partition basis, which anchor frame or frame from the second set of frames to reference;
encoding the third set of frames as a second enhancement encoded layer with each frame of the third set encoded as a P frame;
encoding the third set of frames as a third enhancement encoded layer with each frame of the third set encoded as a B frame;
generating an information label to specify at least one decoder profile corresponding to the baseline encoded layer, the first enhancement encoded layer, the second enhancement encoded layer and the third enhancement encoded layer; and
grouping the baseline encoded layer, the first enhancement encoded layer, the second enhancement encoded layer, the third enhancement encoded layer and the information label to form an encoded video bitstream.
